(19) United States
(12) Patent Application Publication
(10) Pub. No.: US 2026/0162484 A1
(43) Pub. Date: Jun. 11, 2026

(54) VENDING MACHINE MANAGEMENT SYSTEM WITH REMOTE PRICE CHANGES

(71) Applicant: USConnect, LLC, Greensboro, NC (US)

(72) Inventors: Jeff Whitacre, Greensboro, NC (US); Konrad Alvarino, Greensboro, NC (US); Aaron Sorgius, Greensboro, NC (US); Glenn Butler, Greensboro, NC (US)

(73) Assignee: USConnect, LLC, Greensboro, NC (US)

(21) Appl. No.: 18/973,672

(22) Filed: Dec. 9, 2024

(51) Int. Cl. G07F 9/00; G06Q 10/087

(52) U.S. Cl. CPC G07F 9/002; G06Q 10/087

(57) ABSTRACT

A vending machine management system practices a method for remote price changes. The method includes communicating with vending machines, on a server-side on-demand basis. The method includes determining, on a server-side basis, price changes for retail products that are in the vending machines. The method includes pushing the price changes to the vending machines, by the vending machine management system.

### TECHNICAL FIELD

The technical field of the present disclosure relates to vending machines and other point of sale devices, and further relates to automated vending technology.

### BACKGROUND

Vending machines and other point of sale devices offer retail products, stocked in the machine, for on the spot purchase and dispensing to a consumer, the process and technology may be known as automatic vending. Modern vending machines typically have an embedded processing unit, which keeps track of product stock in the machine, prices, transactions (e.g., cash, credit card, cashless), operation of a dispensing mechanism, service needs, etc. Yet, much of the day-to-day operation of a typical vending machine depends on service visits, e.g., for restocking, cash removal. Pricing for the retail products may or may not be optimal for a given circumstance, and may not be readily updated in a timely manner to account for such circumstances. Therefore, there is a need in the art for a technological improvement which overcomes the drawbacks described above.

### SUMMARY

Described herein are various embodiments for remote price changes for vending machines. In the embodiments, and variations thereof, communication is established with vending machines, price changes are determined and pushed to the vending machines. Embodiments may be processor-based, may operate on a server-side basis, may operate on an on-demand basis, and may communicate and push the price changes on an individual vending machine basis.

One embodiment is a method for remote price changes. The method may be practiced by a processor-based vending machine management system. The method includes communicating with each of a plurality of vending machines. This communicating is on at least a server-side on-demand basis. This communicating is by the processor-based vending machine management system. The method includes determining price changes for one or more retail products that are in one or more of the vending machines. This determining is on a server-side basis. The method includes pushing the price changes to the vending machines. This pushing is on an individual vending machine basis. This pushing is by the vending machine management system. This pushing uses server-side on-demand communication.

One embodiment is a vending machine management system. The vending machine management system includes a memory, a network-connectable communication interface, and at least one processor. The memory is arranged to have a database that includes planograms. The planograms indicate placement of retail products in association with prices of the retail products, for vending machines. The processor(s) is to communicate with the vending machines, on a server-side on-demand basis (or more), and this communicating is by the vending machine management system. The processor(s) is to determine price changes for one or more retail products that are in one or more of the vending machines. This price change determining is on a server-side basis. The processor(s) is to push the price changes to the vending machines. This pushing of the price changes is on an individual vending machine basis, is by the vending machine management system, and is using server-side on-demand communication.

One embodiment is a tangible, non-transitory, computer-readable media. The media has instructions that are executable by a processor. The instructions, when executed by the processor, cause the processor to perform a method. The method includes communicating with each of a plurality of vending machines. This communicating is on at least a server-side on-demand basis. This communicating is by a vending machine management system. The method includes determining price changes for one or more retail products that are in one or more of the vending machines. This determining is on a server-side basis. The method includes pushing the price changes to the vending machines. This pushing is on an individual vending machine basis. This pushing is by the vending machine management system. This pushing uses server-side on-demand communication.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of a vending machine management system provided in accordance with the present disclosure including a network connected to user devices and vending machines.

FIG. 2 is a block diagram of the vending machine management system of FIG. 1.

FIG. 3 is a block diagram of the vending machine of FIG. 1, which is generalizable across vending machines and other point of sale devices.

FIG. 4 a block diagram of the vendor management system of FIG. 1.

FIGS. 5A-5I illustrate screenshots of a user interface of the vending machine management system of FIG. 1.

FIG. 6 a flow chart of a method of operation of a vending machine management system in accordance with embodiments of the present disclosure.

### DETAILED DESCRIPTION

Technological improvement in vending machine technology is seen in embodiments of a vending machine management system that features remote price changes for vending machines, which may also relate to other types of point of sale devices. These systems, related technological methods or processes, and variations thereof can be used to support homogeneous or heterogeneous groups of vending machines, and some embodiments support cross-platform mixes of vending machines and vending machines cooperated with vending machine management systems. Remote price changes are pushed in various embodiments on an individual machine or device basis, using server-side on-demand communication. Price changes can be entered through a user interface in some embodiments and/or determined automatically by the system in some embodiments. Price changes are propagated and synchronized throughout the system and the vending machines for coherency and rapid response to conditions or circumstances, improving upon past price change processes, vending machine or automated vending technology, and operator practices with such machines and technology.

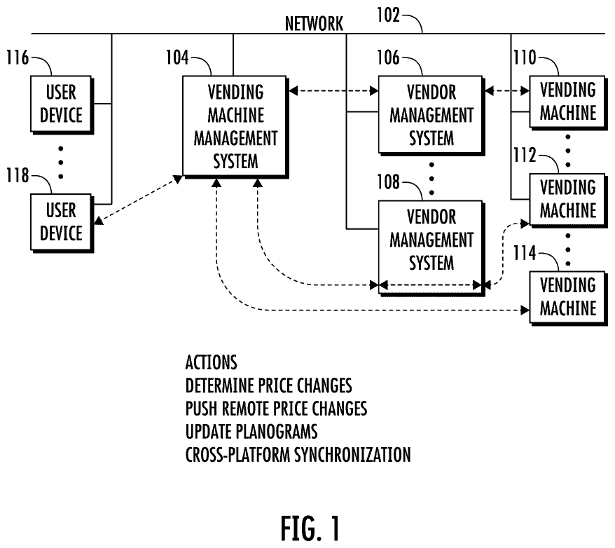

FIG. 1 depicts embodiments of a vending machine management system 104 that features remote price changes for vending machines, here shown network connected with user devices 116, 118, vending machines 110, 112, 114, and vendor management systems 106, 108. Operating scenarios are described below. The network 102 and network connections thereto could be wired, wireless, or combinations thereof, for example connection through Wi-Fi, the Internet and/or cellular network(s). Relatedly, the vending machine management system 104 could be implemented using one or more computing devices, server(s), cloud services, virtual computing, distributed computing, multiprocessing, local storage, cloud storage, etc., in various embodiments with connection to the network 102. Some embodiments may be considered to bring vending machines into the Internet of Things (IoT).

Users of the vending machine management system 104, for example owners and/or operators of vending machines, can connect to and communicate with the vending machine management system 104 through various user devices 116, 118, which could be personal computers, laptops, tablets, smart phones, personal digital assistants, etc. For example, users may interact with the vending machine management system 104 through a user interface presented by the vending machine management system 104 through an app or a browser window on a user device 116, 118.

In various embodiments, the vending machine management system 104 can communicate through the network 102 directly with a vending machine 114, communicate through a vendor management system 108 with a vending machine 112 and/or communicate directly with a vendor management system 106, which communicates directly with a vending machine 110. These differing communication paths may have differing timing, time intervals or delays.

In embodiments, a user communicates a remote price change through a user device 118 to the vending machine management system 104. The vending machine management system 104 pushes the price change directly to a vending machine 114, for example as identified through user communication. Although indicated in the dashed lines, it is understood these communications go through the network 102.

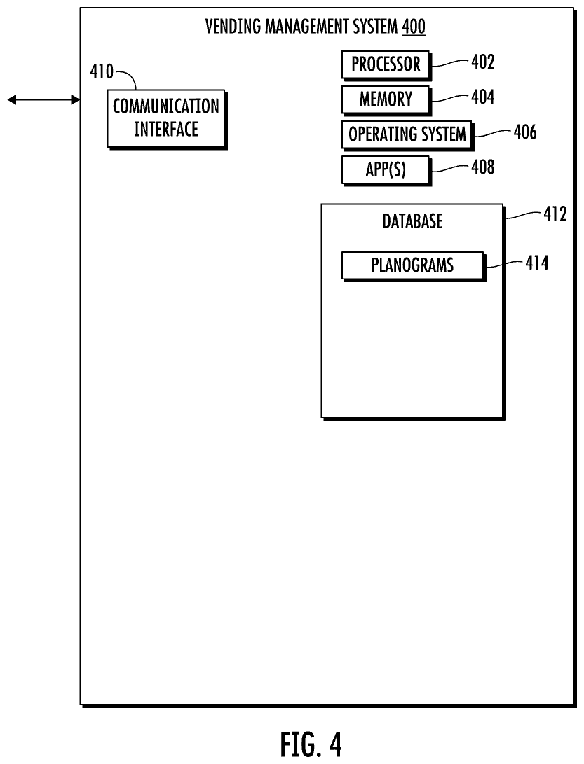

In some embodiments, a user communicates a remote price change through a user device 118 to the vending machine management system 104, which pushes the price change through a vendor management system 108 to a vending machine 112. The vendor management system 108 may handle specific communication protocols with the vending machine 112, for example through an operating system or application(s) (see FIG. 4). Here, the vendor management system 108 may act in a communication transfer and translation mode, with appropriate handshaking to coordinate in both directions, with the vending machine management system 104 and the specific vending machine 112. It is understood a specific vendor management system 108 may connect to multiple vending machines 112 of a same or different type (homogeneous or heterogeneous), in some embodiments.

In certain embodiments, a user communicates a remote price change through a user device 118 to the vending machine management system 104, which pushes the price change to a vendor management system 106. As above, that vendor management system 106 may handle specific communication protocols with the vending machine 110, but in this example may have timings or delays such as set communication intervals or scheduled communication sessions. As above, the vendor management system 106 act in a communication transfer and translation mode, but the communication transfer is not as immediate.

The further components that make up the larger system, in various embodiments, are described below. It is understood that various combinations of equipment can be coordinated and operated through the vending machine management system 104, and that such cross-platform connectivity, communication and handling of remote price changes provides advantageous flexibility to users (e.g., owners, operators of vending machines). Particularly, there is opportunity for making remote price changes to vending machines in a variety of connections and operating circumstances.

FIG. 1 summarizes, in a broad sense, some of the capabilities of embodiments of the vending machine management system 104, as actions. In embodiments, an action may be to determine or execute price changes. The system may determine price changes for retail products in one or more specific vending machines through user interaction and/or through machine-based decision-making (e.g., rules 220). The system can push remote price changes, so determined, to specific vending machine(s). Such remote price change(s) are communicated and enacted on a server-side on-demand basis, in various embodiments. The system can update the planograms, in both directions, from users to vending machines and from vending machines to users, with the vending machine management system 104 acting as a central point of information or “point of truth”. The system can perform cross-platform synchronize, specifically synchronizing planograms and planogram data in the database of the vending machine management system 104, database(s) of vendor management system(s), and vending machine(s). Such synchronizing relates both to planogram data of user origin (e.g., user instructions for remote price changes through user devices 116, 118) and planogram data generated through automated decision-making (e.g., remote price changes based on rules 220).

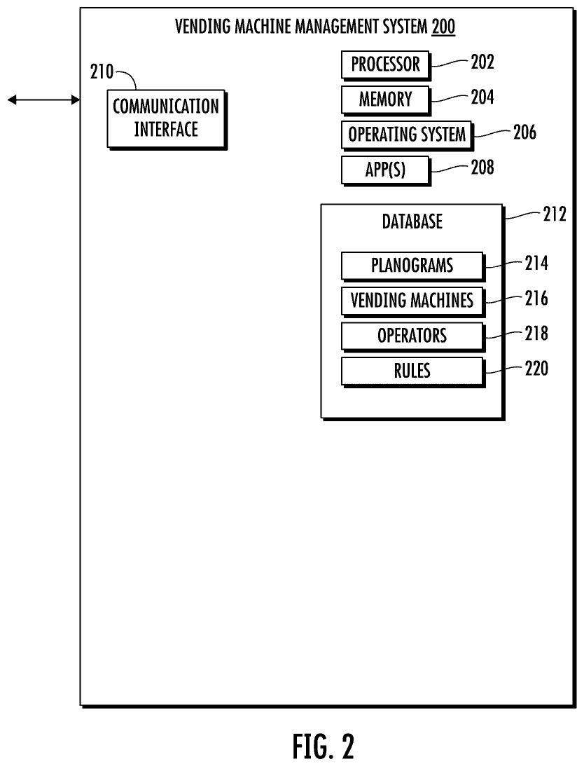

FIG. 2 depicts embodiments of a vending machine management system, which may be used for remote price changes for vending machines as shown in FIG. 1. Since the vending machine management system 200 is computerized, there is a processor 202, a memory 204, and there may be an operating system 206 and one or more apps 208, or other programming for the processor to execute. A communication interface 200 supports connection to a network for communication with user device(s), vending machine(s), vendor management system(s), etc. For example, the communication interface 200 could be wired or wireless, support connection to an appropriate network, and support an appropriate communication protocol. A database 212 is herein depicted implemented as part of the computing system, but could also be implemented with remote access, for example cloud storage, networked storage, distributed memory, distributed database, virtual computing, etc. Specifically, the database 212 is arranged for data in association, including data of planograms 214, vending machines 216, operators 218, and possibly also rules 220 (e.g., for rule-based decisions as may be used for automated aspects of vending machine management).

“Planogram” is a term of art, and may generally be a diagram or model that indicates placement of retail products, e.g., on shelves or other display. In the present context, a planogram indicates placement of retail products in a vending machine, and may be embodied in data indicating names, quantities, prices and arrangement (e.g., physical placement row, column, selection identifier). For example, a planogram in data form can be stored in a database 212, rendered for display to a user as text or graphics, and interacted with by user selection through a computer and/or by computer processes. Particularly, the database can be a relational database, in which entries and their relationships among one another are in association. For example, aspects of each retail product, such as name of the product, its location in the vending machine (e.g., a coded selection identifier), the price of the retail product, and possibly further information, could be stored in relation to one another in a planogram for each specific vending machine managed through the vending machine management system 200, in a database 212. That is, the planograms 214 corresponding to the operators 218 and the vending machines 216 can be written to, accessed, updated or revised, etc., in the database 212. Each of the planograms 214 corresponds with and is associated with a respective operator and a respective vending machine, in various embodiments. Rules 220 could be operator-specific, vending machine specific, or more general, and could have conditions or parameters.

For example, a rule could be to change prices based on time of day, such as morning pricing, midday pricing, late-night pricing, or change prices based on inventory in the vending machine (and inventory indexing), such as reducing prices to sell off inventoried food items before expiration (e.g., stale or spoilage), or increasing prices to sell popular fast-moving products at higher profit. Surge pricing, emergency pricing, conditional pricing based on whether other stands or restaurants are open or closed, end of day pricing, etc. may be implemented through rules 220. Hourly, daily, weekly, monthly, seasonal or other scheduled pricing and price changes could be implemented through rules 220. Rules 220 may combine automated price changes and user initiated price changes. Rules 220 may be implemented explicitly in a rule-based system, e.g., with a list of explicit rules, or implicitly in programming, e.g., embedded in software, or other variations devised by those of skill in the art.

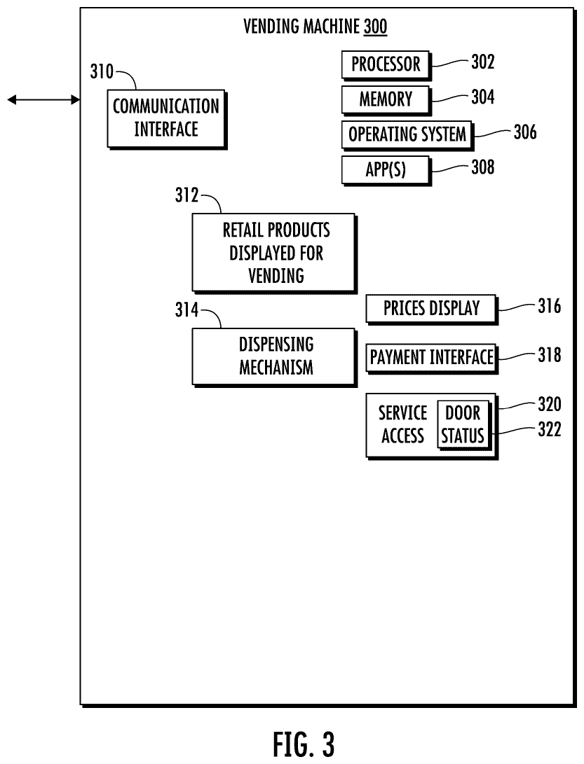

FIG. 3 depicts embodiments of a vending machine 300, which is generalizable across vending machines 110, 112, 114 and other point of sale devices. In these embodiments, the vending machine 300 has an embedded computer, with a processor 302, memory 304, operating system 306, and one or more apps 308. There is also a communication interface 310, for network connection and communication. It is through the communication interface 310, and the network 102, that the vending machine management system 104 and/or vendor management system 106, 108 may communicate with the vending machine 300. Typically, a transparent window allows a customer to see part of a dispensing mechanism 314 (e.g., racks, shelves, rotatable spiral wire) on which are arranged retail products displayed for vending 312. A prices display 316, e.g., liquid crystal display, LED display, touchscreen, etc., shows prices for the retail products, for consideration by the customer. The prices display 316 is coupled to the processor 302, and that is how current prices and any price changes are to be made visible at this location. A payment interface 318 handles payment such as cash or credit cards, or smart phone transactions, for vending product. A service access 320 may include mechanical (e.g., key) or electronic (e.g., keypad) lock, one or more sensors for door status 322, a user interface (e.g., screen, buttons) for service personnel, etc. As commonly understood, the customer views the retail products and prices, enters a selection and makes payment through the payment interface 318, whereupon the vending machine 300 operates the dispensing mechanism 314 and dispenses the selected (and paid for) retail product.

In some embodiments, a vending machine 300 may require the door to be open for prices to be updated. In such embodiments, a tentative price change may be loaded into the machine and require a restocker to acknowledge the price change when the door is open such that the vending machine updates the prices display 316. For example, the open door could be detected by the sensor(s) for door status 322, and programming in the vending machine 300 could have conditional updates for the prices display based on door status 322. Programming in the vending machine 300 may be altered via communication with the vending machine 300, e.g., software update or revision.

FIG. 4 depicts a vendor management system 400, which may be used by some operators of vending machines, for planograms 414. For example, an operator (also known as a vendor) may be operating one or more vending machines out on location, through the use of a VMS or vendor management system 400, prior to contracting for services or becoming a user of the vending machine management system 104, 200. When an operator uses the vending machine management system 104, 200, for example to push remote price changes to vending machines 114 associated with that operator, the vending machine management system 104, 200 may communicate directly with the vending machine 114, bypassing a vendor management system. In some embodiments, the vending machine management system 104, 200 may communicate with the vending machine 114 through the vendor management system 108, or may communicate to the vendor management system 108 which then communicates with the vending machine 110, in various scenarios and connections as described with reference to FIG. 1. The vendor management system 400 may participate in transferring services thusly, for example through updating programming of a given vending machine 112 for either responsiveness to server-side on-demand communication from the vending machine management system 104 and/or server-side on-demand communication from the vendor management system 108, 400.

In the embodiments in FIG. 4, the vendor management system 400 is computerized and has a processor 402, memory 404, a communication interface 410, and may have an operating system 406 and/or one or more apps 408. For storage and access to planograms 414, the vendor management system 400 has a database 412.

Typically, prior to disclosure with of present embodiments and improvements to automated vending technology, a vendor management system 400 was used to upload planogram data and/or service information from vending machines at specified times (e.g., midnight), and download pricing (e.g., set prices or price changes) at specified times, and would not ordinarily have capability of pushing remote price changes to vending machines on-demand from the server side, e.g., upon operator instruction. Thus, pushing remote price changes to vending machines, on-demand from the server side, is an improvement in automated vending technology, as shown in present embodiments.

With reference to FIGS. 1-4, in some embodiments a revision or update to programming in vending machine(s) 110, 112, 114 supports the server-side on-demand communication from the vending machine management system 104, including pushing remote price changes. For example, a vending machine 110 may have programming that only accepts incoming communication at scheduled times, or only accepts incoming communication in response to outgoing communication from the vending machine 110, and this can be altered through vendor management system 400 communicating a software or programming update or revision, to the vending machine 110. Or, the vending machine management system 200 may communicate a software or programming update or revision to the vending machine 110. Still further, the vending machine management system 200 may communicate an instruction to a vendor management system 400, to communicate a software or programming update or revision to the vending machine 110.

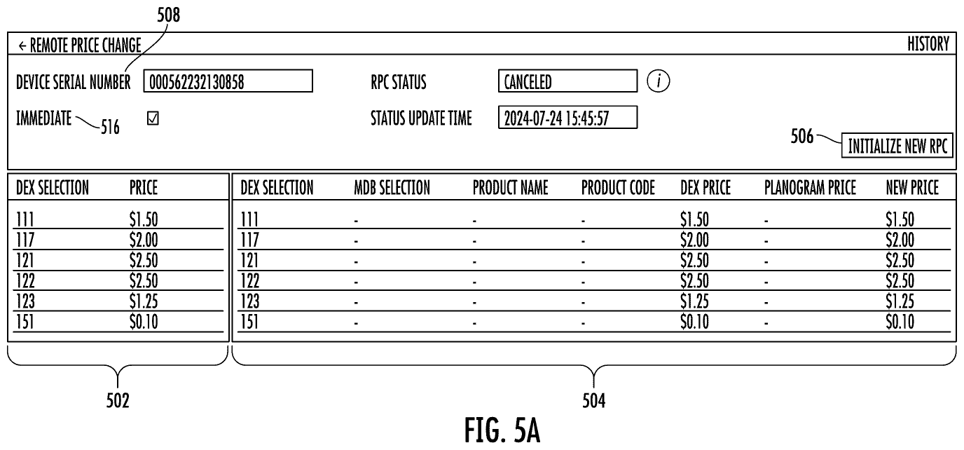

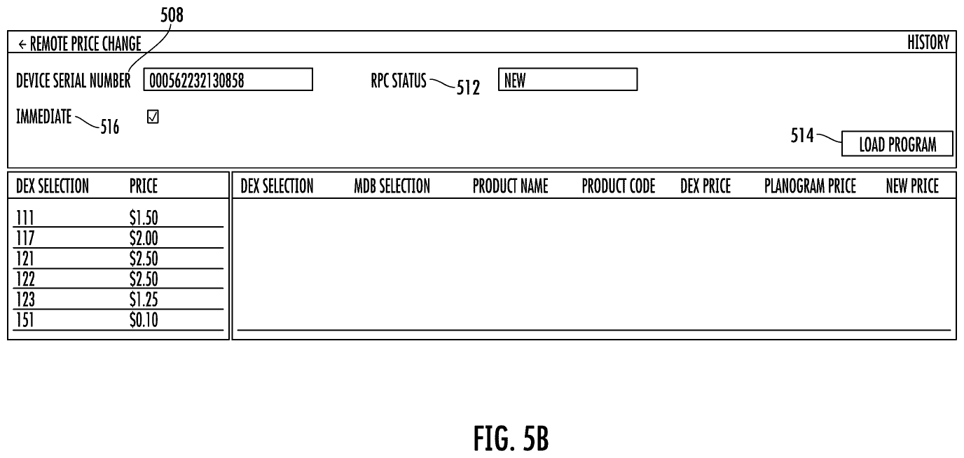

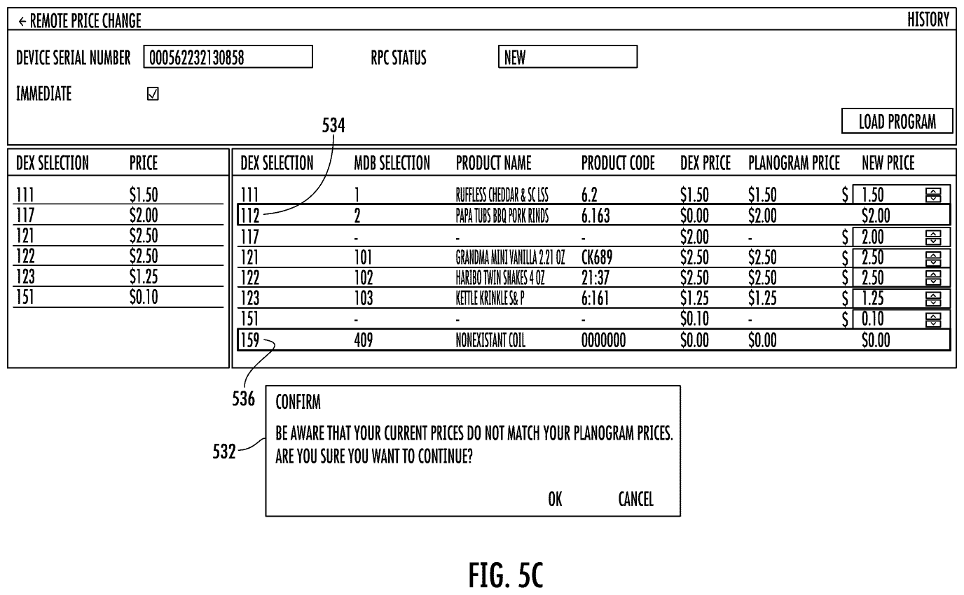

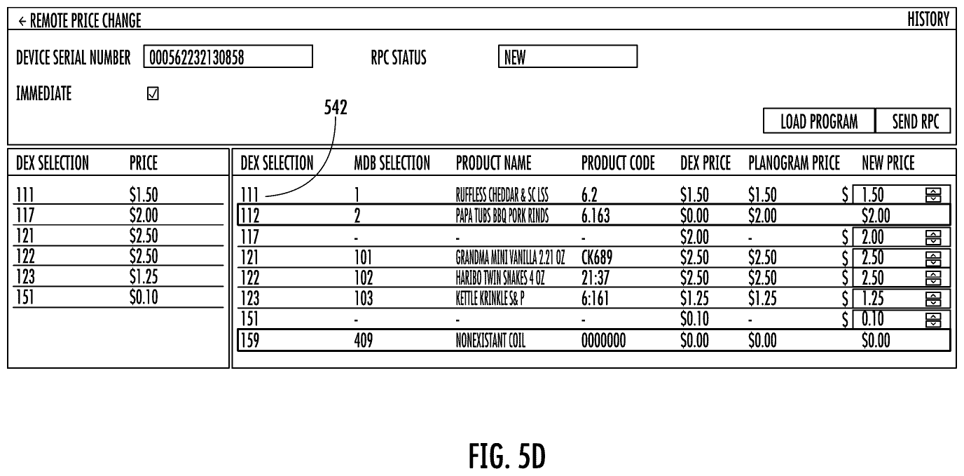

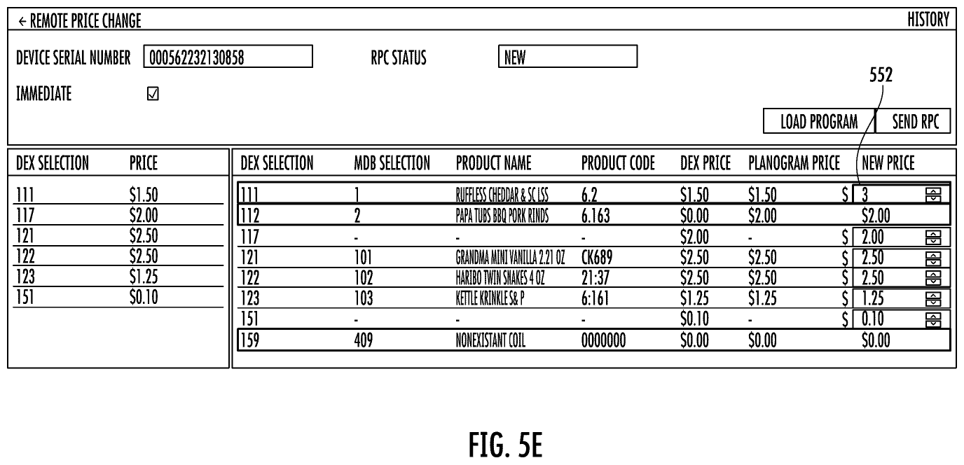

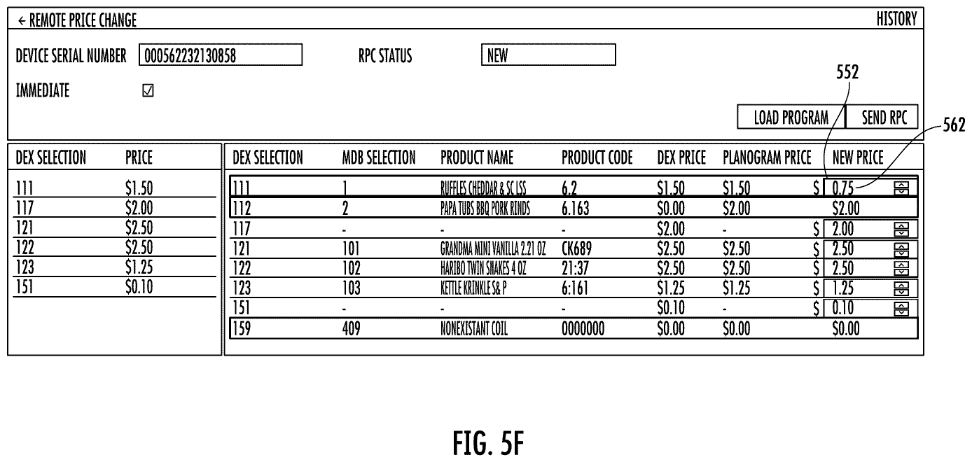

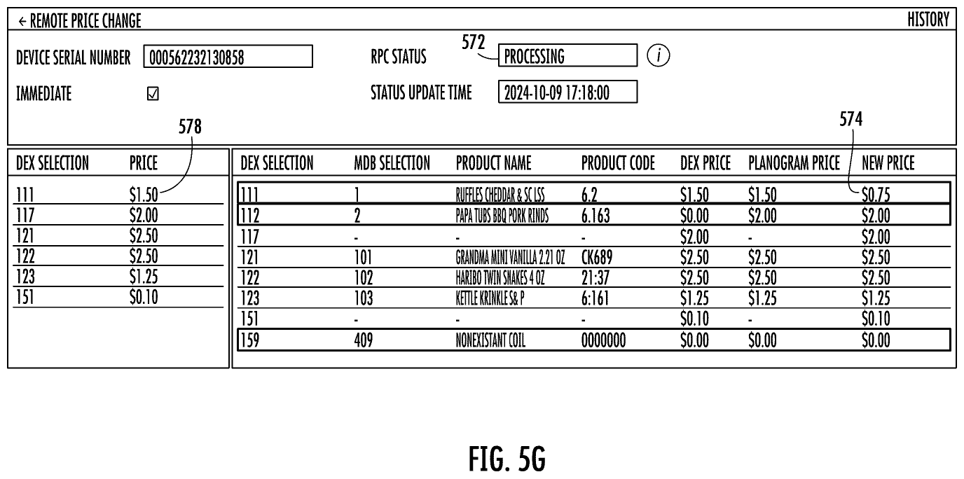

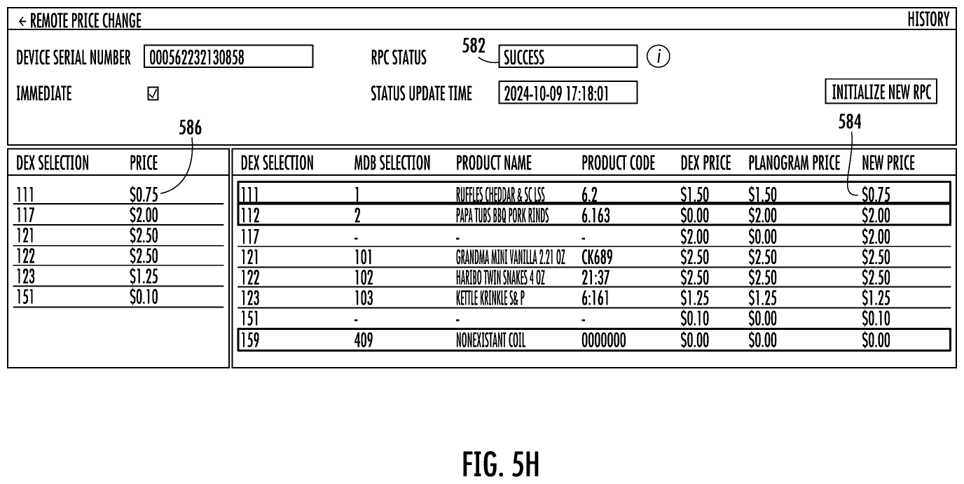

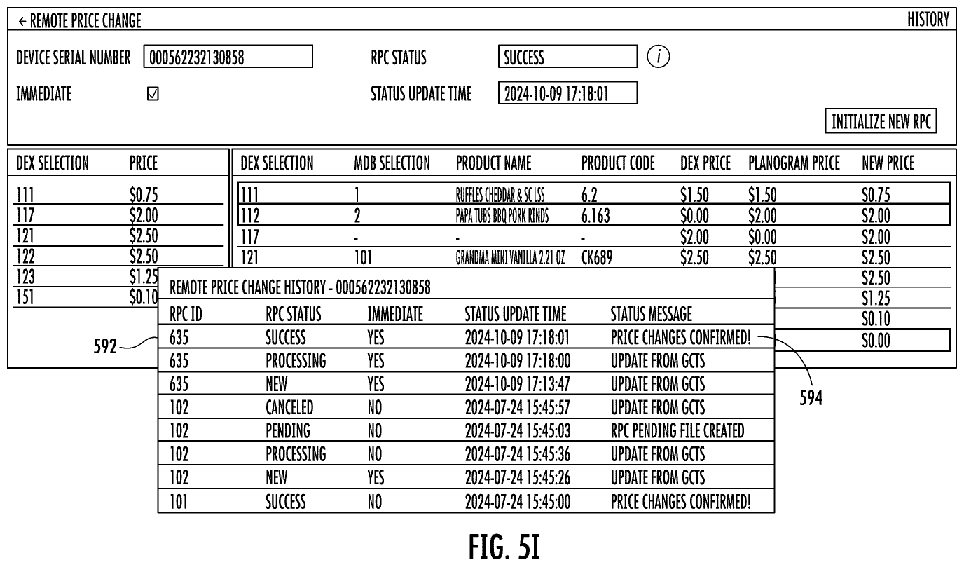

FIGS. 5A-5I depict screenshots of a user interface, in an example sequence featuring a remote price change as could be performed using embodiments of the vending machine management system 104, 200. For example, the operating system 206 and/or one or more of the apps 208 could generate a user interface, and communicate same through the communication interface 210 and the network 102, to a user device 116, 118, for example through a browser window or an app on the user device. With the user device 116, 118, the user can interact through the user interface to instruct or request the vending machine management system 104, 200 to perform various actions including pushing remote price changes to one or more specific vending machines 110, 112, 114.

FIG. 5A shows a device serial number 508, corresponding to a specific vending machine that is the target for the remote price change that will be pushed when the operator (or more generally, user) selects soft button 506 “initialize new RPC”, to initialize a new remote price change. It is understood other mechanisms such as drop-down menus, pop-up boxes, speech recognition, command line interface, etc., could be applied in variations. One data field 502, on the left, shows planogram data in the form of “DEX selection”, which may specify the location of a retail product in the vending machine, e.g., a retail product selection identifier, and “price”, which specifies the price of a selectable retail product in the vending machine. For example, “DEX” may be interpreted as a retail product index relative to the vending machine, identifying retail products (and in some embodiments, quantities thereof) that are actually indexed as being present in the vending machine and available for selection and payment, for vending. Typically, the retail product selection identifier and associated price are displayed on the vending machine, e.g., see prices display 316 in FIG. 3, so that the user may specify a retail product selection and pay for same, e.g., through the payment interface 318. Continuing with the screenshot of user interface in FIG. 5A, another data field 504, on the right, shows the same planogram information, but with blanks where uploaded information from the vending machine will update.

FIG. 5B follows the user selection to initialize new RPC, and shows for RPC status 512 that the remote price change capability setting 516 is “immediate”, meaning that the vending machine corresponding to the device serial number 508 (in FIG. 5A) is capable of immediate remote price change. For example, the specific vending machine may have had revised programming to respond to server-side on-demand communication, or a vendor management system 108 coupled to the vending machine may have been set up for communication transfer and translation with low delay to qualify as “immediate”. A soft button 504 labeled “load program” can be selected by the user, to upload planogram data from the specified vending machine, as will be seen in FIG. 5C.

FIG. 5C follows user selection to “load program”, and now shows the uploaded planogram data in full detail with DEX selection, MDB selection, product name, product code, DEX price, planogram price, new price. For example, MDB selection may be an identifier referring to a database 212 of a vending machine management system 200, such as MongoDB, a specific commercial database. For example, product name may be the name of the retail product as specified by the manufacturer or supplier. For example, product code may be a supplier or vendor-applied code to identify the retail product. DEX price and planogram price may be equal where the specific retail product remains available in the vending machine (e.g., from a previous service visit and product is not yet sold out). Or, DEX price and planogram price may differ, see example line 534 of DEX selection 112 highlighted, where a new product has been placed in the vending machine, e.g., from a recent or current service visit, with pricing information now uploaded but not previously known from a DEX price. In a further example line 536, also highlighted, a “nonexistent coil” is reported for product name, where there is no product and possibly not even a dispensing mechanism location for a product, in the vending machine. An acknowledgment or confirmation message 532 has contents, “Confirm Be aware that your current prices do not match your planogram prices. Are you sure you want to continue? Okay Cancel”.

FIG. 5D depicts the user interface that a user is perusing, in order to select an example line 542 for a price change. Here, the user is interested in DEX selection 111, shown with DEX price, planogram price and new price (prior to change) all equal $1.50.

FIG. 5E shows that the price field 552 is now empty (or blank) for the selected price of the product identified by DEX selection 111 “ruffles cheddar & SC LSS” (e.g., a type of cheddar cheese flavored potato chip with sour cream and low sodium or low salt). Note that there are up and down arrows which could be used to bump the price up or down, and further mechanisms for setting price are understood in variations.

FIG. 5F shows that the user has entered the amount of $0.75 as the price 562 in the price field 552 under the heading “new price”, for the retail product identified as DEX selection 111.

FIG. 5G shows Processing 572 as RPC status, with the amount of $0.75 as the price 574 being processed, while the amount $1.50 still shows as the price 576 from the earlier DEX information associated to DEX selection 111.

FIG. 5H shows RPC status success 582, with the amount $0.75 shown as the new price 584 and also the price 586 associated to the DEX selection 111. For example, in order to get to this success screen, in the background the remote price change with price of $0.75 was pushed from the vending machine management system 104 to the indicated, selected vending machine, either directly or through a vendor management system. Then, the vending machine has sent back a confirmation that the remote price change is implemented in the vending machine and/or sent back an updated planogram that includes the updated remote price change, or alternatively the vending machine has sent back planogram data only for the changed price and associated retail product. With reference back to FIGS. 1 and 2, the vending machine management system 200 updates the corresponding planogram in the database 212, according to such acknowledgment of remote price change from the vending machine, in some embodiments.

FIG. 5I shows, in the user interface, a message 592 with remote price change history. For example, the remote price change history could indicate a specific device serial number or other identifier for the specific vending machine, with history entries including time and date stamps, RPC status of success, processing, new, canceled or pending, a status or setting of yes or no for “immediate” for that specific machine, and an identifier for which remote price change is considered as “RPC M”, and a status message such as “price changes confirmed”, updated, RPC pending file created, etc. This message 592 could be termed a report.

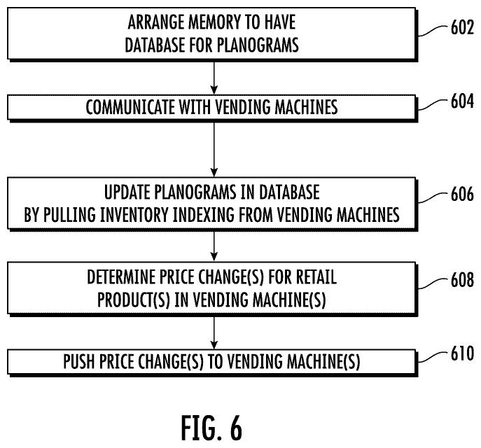

FIG. 6 depicts a flow diagram of a method of operation of a vending machine management system, in embodiments of a process which could be performed using embodiments described herein and variations thereof. Particularly, the method may be performed by a specially programmed, special purpose computer, interacting with computerized vending machines.

In an action 602, the vending machine management system arranges memory to have a database for planograms. System, memory, database, processing, etc. may be centralized, distributed, virtual computing, virtual storage, cloud-based, etc., in various embodiments.

In an action 604, the vending machine management system communicates with vending machines. For example, the communication could be wired or wireless, and/or through one or more networks such as the Internet, cellular network, etc.

In an action 606, the vending machine management system updates planograms in the database, by pulling inventory indexing from the vending machines. For example, the inventory indexing and the planogram could specify identifiers for retail products, including locations, quantities and prices of the retail products currently stocked in the vending machine.

In an action 608, the vending machine management system determines price changes for retail product(s) in the vending machine(s). For example, a price change could be determined through a user interface, from user interaction with the system. Or, a price change could be determined automatically by the vending machine management system, for example based on rules, conditions, etc.

In an action 610, the vending machine management system pushes the price change(s) to the vending machine(s). Price changes may be pushed on a server-side on-demand basis, rather than waiting for vending machine-initiated communication. Price change(s) may be pushed on a per vending machine basis. Price change(s) may be pushed directly from vending machine management system to vending machine(s), or may be pushed from the vending machine management system through a vendor management system to the vending machine(s). Homogeneous and heterogeneous mixes of vending machines and/or vendor management systems may be supported.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method for remote price changes, practiced by a processor-based vending machine management system, the method comprising:
communicating with each of a plurality of vending machines, on at least a server-side on-demand basis, by the processor-based vending machine management system;
determining, on the server-side basis, price changes for one or more retail products that are in one or more of the plurality of vending machines; and
pushing the price changes, to the corresponding one or more of the plurality of vending machines, on an individual vending machine basis, by the processor-based vending machine management system, using the server-side on-demand communication.

2. The method of claim 1, further comprising:
receiving acknowledgment of completion of remote price change from the one or more of the plurality of vending machines; and
updating each corresponding planogram in a database associated with the processor-based vending machine management system, according to each acknowledgment of completion of remote price change.

3. The method of claim 1, further comprising:
arranging a memory to have a database comprising planograms that indicate placement of retail products in association with prices of the retail products for vending machines;
pulling inventory indexing from each of the plurality of vending machines, by the processor-based vending machine management system; and
updating the planograms in the database according to the inventory indexing pulled from each of the plurality of vending machines.

4. The method of claim 1, wherein determining the price changes on the server-side basis comprises:
receiving one or more of the price changes through a user interface, by the processor-based vending machine management system.

5. The method of claim 1, wherein determining the price changes on the server-side basis comprises:
changing at least one price based on a schedule, by the processor-based vending machine management system.

6. The method of claim 1, wherein determining the price changes on the server-side basis comprises:
changing at least one price based on the inventory indexing, by the processor-based vending machine management system.

7. The method of claim 1, wherein determining the price changes on the server-side basis comprises:
changing at least one price based on a price change rule, automatically, by the processor-based vending machine management system.

8. The method of claim 1, wherein communicating with each of the plurality of vending machines comprises:
communicating with a vending machine system that communicates with at least one of the plurality of vending machines.

9. The method of claim 1, wherein pushing the price changes comprises:
communicating at least one price change to a vending machine system that communicates the at least one price change to at least one of the plurality of vending machines.

10. The method of claim 1, further comprising:
synchronizing a database comprising planograms, associated with the processor-based vending machine management system, with at least one further database associated with at least one of the plurality of vending machines.

11. A vending machine management system, comprising:
a memory, arranged to have a database comprising planograms that indicate placement of retail products in association with prices of the retail products for vending machines;
a network-connectable communication interface; and
at least one processor, to:
communicate with each of a plurality of vending machines, on at least a server-side on-demand basis, through the network-connectable communication interface, by the vending machine management system;
determine, on the server-side basis, price changes for one or more retail products that are in one or more of the plurality of vending machines; and
push the price changes, to the corresponding one or more of the plurality of vending machines, on an individual vending machine basis, by the vending machine management system, using the server-side on-demand communication.

12. The vending machine management system of claim 11, wherein the at least one processor is further to:
receive acknowledgment of completion of remote price change from the one or more of the plurality of vending machines; and
update each corresponding planogram in a database associated with the vending machine management system, according to each acknowledgment of completion of remote price change.

13. The vending machine management system of claim 11, wherein the at least one processor is further to:
arrange a memory to have a database comprising planograms that indicate placement of retail products in association with prices of the retail products for vending machines;
pull inventory indexing from each of the plurality of vending machines, by the vending machine management system; and
update the planograms in the database according to the inventory indexing pulled from each of the plurality of vending machines.

14. The vending machine management system of claim 11, wherein to determine the price changes, the at least one processor is to:
receive one or more of the price changes through a user interface.

15. The vending machine management system of claim 11, wherein to determine the price changes, the at least one processor is to:
change at least one price based on a schedule.

16. The vending machine management system of claim 11, wherein to determine the price changes, the at least one processor is to:
change at least one price based on the inventory indexing.

17. The vending machine management system of claim 11, wherein to determine the price changes, the at least one processor is to:
change at least one price based on a price change rule, automatically.

18. The vending machine management system of claim 11, wherein to communicate with at least one of the plurality of vending machines, the at least one processor is to:
communicate through the network-connectable communication interface with a vending machine system that communicates with at least one of the plurality of vending machines.

19. The vending machine management system of claim 11, wherein to push the price changes, the at least one processor is to:
communicate at least one price change through the network-connectable communication interface to a vending machine system that communicates the at least one price change to at least one of the plurality of vending machines.

20. The vending machine management system of claim 11, wherein the at least one processor is further to:
synchronize a database comprising planograms, associated with the vending machine management system, with at least one further database associated with at least one of the plurality of vending machines.

21. A tangible, non-transitory, computer-readable media having instructions thereupon which, when executed by a processor, cause the processor to perform a method comprising:
communicating with each of a plurality of vending machines, on at least a server-side on-demand basis, by a vending machine management system;
determining, on the server-side basis, price changes for one or more retail products that are in one or more of the plurality of vending machines; and
pushing the price changes, to the corresponding one or more of the plurality of vending machines, on an individual vending machine basis, by the vending machine management system, using the server-side on-demand communication.

22. The tangible, non-transitory, computer-readable media of claim 21, wherein the method further comprises:
receiving acknowledgment of completion of remote price change from the one or more of the plurality of vending machines; and
updating each corresponding planogram in a database associated with the vending machine management system, according to each acknowledgment of completion of remote price change.

23. The tangible, non-transitory, computer-readable media of claim 21, wherein the method further comprises:
arranging a memory to have a database comprising planograms that indicate placement of retail products in association with prices of the retail products for vending machines;
pulling inventory indexing from each of the plurality of vending machines, by the vending machine management system; and
updating the planograms in the database according to the inventory indexing pulled from each of the plurality of vending machines.

24. The tangible, non-transitory, computer-readable media of claim 21, wherein determining the price changes on the server-side basis comprises:
receiving one or more of the price changes through a user interface, by the vending machine management system.

25. The tangible, non-transitory, computer-readable media of claim 21, wherein determining the price changes on the server-side basis comprises:
changing at least one price based on a schedule, by the vending machine management system.

26. The tangible, non-transitory, computer-readable media of claim 21, wherein determining the price changes on the server-side basis comprises:
changing at least one price based on the inventory indexing, by the vending machine management system.

27. The tangible, non-transitory, computer-readable media of claim 21, wherein determining the price changes on the server-side basis comprises:
changing at least one price based on a price change rule, automatically, by the vending machine management system.

28. The tangible, non-transitory, computer-readable media of claim 21, wherein communicating with each of the plurality of vending machines comprises:
communicating with a vending machine system that communicates with at least one of the plurality of vending machines.

29. The tangible, non-transitory, computer-readable media of claim 21, wherein pushing the price changes comprises:
communicating at least one price change to a vending machine system that communicates the at least one price change to at least one of the plurality of vending machines.

30. The tangible, non-transitory, computer-readable media of claim 21, wherein the method further comprises:
synchronizing a database comprising planograms, associated with the vending machine management system, with at least one further database associated with at least one of the plurality of vending machines.
